(19) United States
(12) Patent Application Publication
(10) Pub. No.: US 2015/0144634 A1
(43) Pub. Date: May 28, 2015

(54) PAINT CAN RIM RING

(71) Applicant: Mark Farnworth, Vancouver (CA)

(72) Inventor: Mark Farnworth, Vancouver (CA)

(21) Appl. No.: 14/089,763

(22) Filed: Nov. 26, 2013

(51) Int. Cl. B44D 3/12; B65D 45/32

(52) U.S. Cl. CPC B44D 3/127; B65D 45/322
USPC 220/320; 220/350

(57) ABSTRACT

A paint can fitted rim ring apparatus is shown comprising of a snug ring lid retaining a flexible plastic like material around the opening lip of a paint container.

The painting implements such as a paint brush or a painting roller left inside the paint container may protrude outside the lip of the paint container preventing re-sealing the paint container with the lid when not in use.

A flexible plastic like material can be draped over the protruding painting implements as well as covering the paint container opening.

In concert with a plastic type ring when fitted snuggly around the lip of the paint container, seals the flexible plastic like material around the paint container rim, preventing the contents from drying out.

### FIELD

The specific relates generally to painting implements and paint containers with paint contained within.

### BACKGROUND

When the application of paint on surfaces (e.g. walls, cabinets) with a paint implements (e.g. paint brush, paint roller) from a paint container, often painting is interrupted and the paint implements have to be cleaned between uses, adverting paint from drying to the paint implement and the lid of the paint container has to be firmly replaced, to prevent the paint solution from drying out.

### SUMMARY OF THE INVENTION

In accordance with the embodiments of the present invention, a unique painting implements storage device is disclosed that reduces the need to clean painting implements after each use, while still allowing the painting implements to be used at a later time. Furthermore the embodiments of the present invention allows safe storage of paint material at the same time.

### DESCRIPTION OF THE DRAWINGS

FIG. 1. Shows a perspective view of the embodiment of the present invention.

FIG. 2. Shows a cross section view of FIG. 1.

### DETAILED DESCRIPTION OF THE EMBODIMENT OF THE INVENTION

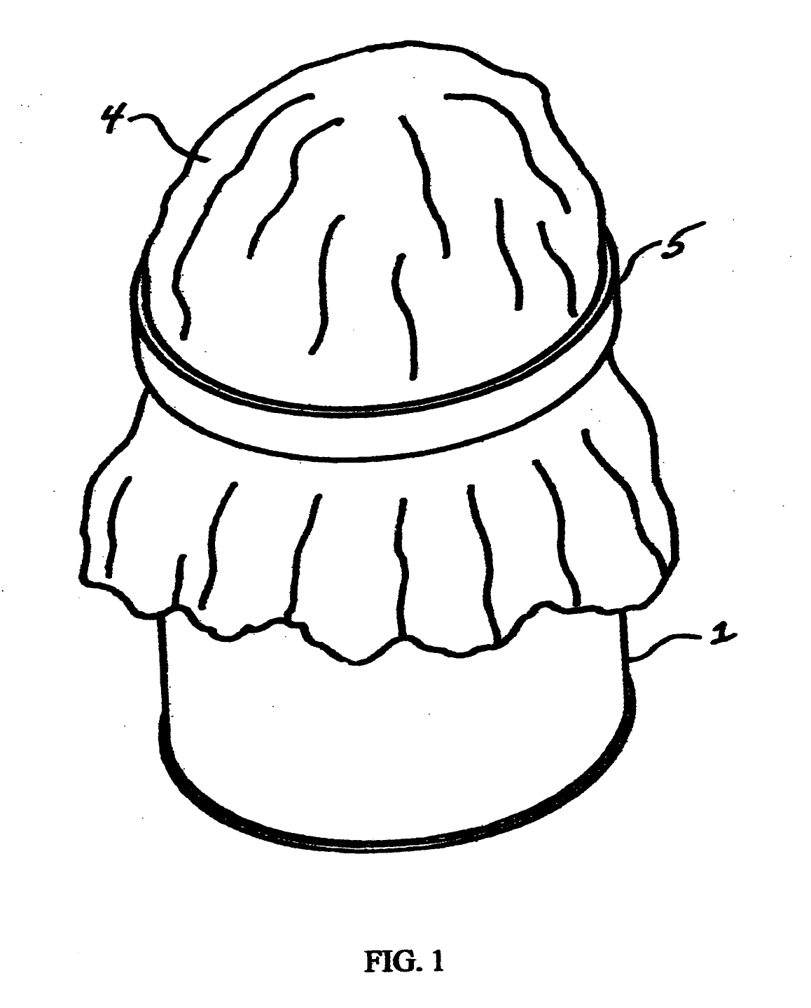

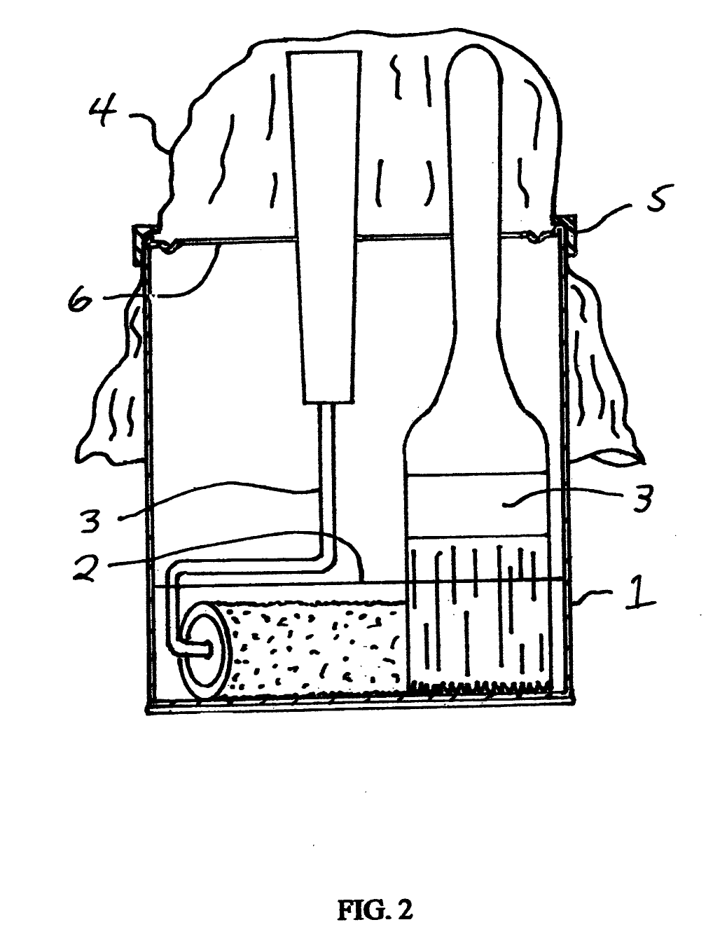

Referring to FIG. 1 and FIG. 2 drawings wherein numbered characters are used as reference to designate corresponding parts in the detailed description of the embodiment of the invention.

There is generally a sealed container 1 that stores paint, varnish or other surface protecting means, which shall be referred herein as paint can 1, which has been opened and the lid has not been replaced. There is paint, varnish or other surface protecting means 2 which shall be referred herein as paint 2 inside the paint can 1, and there can be painting implements 3 such as a paint brush or paint roller which shall be referred herein as paint tools 3 inside the paint can 1 which can be protruding outside the opening of the paint can 1.

Provided is an airtight baggy plastic like material 4 which shall be referred herein as plastic bag 4 that is draped over the open body of the paint can 1 and also covering the paint tools 3 and there is also an inverted L shaped round stretchable gripping ring 5 which shall be referred herein as rim ring 5 which snaps snuggly around the paint can 1 open round rim 6.

Thus in combination when the plastic bag 4 is placed over the paint can 1 open round rim 6 and the rim ring 5 is placed over and around the plastic bag 4 and is fitted snuggly down onto and around the open round rim 6, sealing the plastic bag 4 to the open round rim 6, thus creating an airtight environment inside the paint can 1 preventing evaporation of the contents.

It is also intended that all matter contained in the above description or shown in the accompany drawings shall be interpreted as illustrative and not in a limiting sense. As various changes who are skilled in the art could be made in the above description without departing from the scope of the invention, therefore the scope of the invention should be determined by the applied appended claims hereto.

What is claimed is:

1. An airtight storage device to preserve liquid in a container comprising:
an airtight baggy plastic like material to substantially cover the opening of a liquid holding container; in concert with an inverted L shaped round stretchable gripping ring which is placed down and around the airtight baggy plastic like material until the inverted L shaped round stretchable gripping ring is seated snuggly on the open end round rim of the liquid holding container, sealing the airtight baggy plastic like material around the open end round rim of the liquid holding container.

2. An airtight storage device to preserve liquid in a container of claim 1 wherein the inverted L shaped round stretchable gripping ring when seated snuggly on the open end round rim of the liquid holding container hence sealing the airtight baggy plastic like material around the open end rim of the liquid holding container creating an airtight environment preventing evaporation of the stored liquid.

3. An airtight storage device to preserve liquid in a container of claim 2 wherein the flexibility of the airtight baggy plastic like material allows for implements to protrude from the opening of the liquid holding container and still be contained inside the airtight baggy plastic like material.
